(19) United States
(12) Patent Application Publication
(10) Pub. No.: US 2009/0122385 A1
(43) Pub. Date: May 14, 2009

(54) Direct Retinal Display

(76) Inventor: Peter James Hilton, Christchurch (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/814,435

(22) PCT Filed: Jan. 24, 2006
(86) PCT No.: PCT/NZ06/00005

§ 371 Date: Jul. 20, 2007

(30) Foreign Application Priority Data
Jan. 21, 2005 (NZ) 537849

(51) Int. Cl. G02B 26/00

(52) U.S. Cl. 359/291

(57) ABSTRACT

A direct retinal display (50) for displaying an image on the retina of an eye (62) with a wide field of view. The direct retinal display (50) comprises a scan source (52) that is arranged to generate a scanned optical beam (58), modulated with an image, in two dimensions over a scan angle. The direct retinal display (50) further comprises a diverging reflector (54) in the path of the scanned optical beam (58) that is arranged to reflect the scanned optical beam (58) incident on the diverging reflector (54) outwardly with a magnified scan angle toward a converging reflector (56) that is arranged to reflect the scanned optical beam substantially toward a convergence spot at the pupil (60) of the eye (62) for reconstruction and display of the image on the retina with a wide field of view.

### FIELD OF THE INVENTION

This invention relates to direct retinal displays (DRDs). In particular, it relates to developments to improve the field of view offered by DRDs.

### BACKGROUND TO THE INVENTION

DRDs provide an image for viewing by scanning a laser beam or other optical beam modulated with image information directly onto the retina of a user's eye, via the pupil. More particularly, by utilising several colours of laser beams and modulating the intensity of those beams a colour image can be produced on the user's eye. For example, the image is generated sequentially by scanning a light spot in a raster pattern across the retina.

DRDs provide advantages over existing screen based displays. The resolution can be higher and images can be superimposed over real life scenes. This makes DRDs a desirable option for a wide range of applications especially in virtual or augmented reality displays. For example, a DRD in headset form can provide drivers or pilots with information in a visual form while simultaneously looking at the scene they are navigating.

To match the “real-life” imaging ability of the human eye a display device would ideally have a field of view of 140° horizontally and 90° vertically for a single eyeball. The maximum resolution that the eye can discern is 1 arc minute of angular resolution, which translates to 8400 horizontal by 5400 vertical pixels. The resolution provided by existing DRD techniques depends on the laser wavelength, scanner speed and modulation bandwidth as well as the scanning optics. A diffraction limited laser can produce an angular resolution on the retina of about 1 arc minute. However, the field of view is dictated by a number of factors including the scan speed and modulation bandwidth provided by existing technology. To improve the field of view the scan angle (the horizontal and vertical angle over which the laser beam is scanned on the retina) must be increased. Increasing the scan angle mechanically at the scanner also requires an increase in scan speed and/or modulation bandwidth to keep the same resolution. Therefore, the field of view is limited by the capabilities of current technologies that determine the scan speed and modulation bandwidth.

US Patent Application Publication No. 2004/0164926 proposes a head-mounted display system that scans into the eye of a user via an ellipsoid reflector to provide a wide-field image display.

It is an object of the present invention to provide an improved direct retinal display, or to at least provide the public with a useful choice.

### SUMMARY OF THE INVENTION

In a first aspect, the present invention broadly consists in a direct retinal display for displaying an image on the retina of an eye with a wide field of view comprising: a scan source that is arranged to generate a scanned optical beam in two dimensions over a scan angle in each dimension, the scanned optical beam being modulated with the image; a diverging reflector in the path of the scanned optical beam that is arranged to reflect the scanned optical beam incident on the diverging reflector outwardly with a magnified scan angle; and a converging reflector in the path of the reflected scanned optical beam that is arranged to reflect the scanned optical beam, having a magnified scan angle, substantially toward a convergence spot at the pupil of the eye for reconstruction and display of the image on the retina with a wide field of view.

Preferably, the diverging reflector at least partially may comprise a spherical reflecting surface in the path of the scanned optical beam such that the scanned optical beam incident on the spherical reflecting surface is reflected at an altered angle to magnify the scan angle to create the wide field of view. In one form, the diverging reflector may be a hemispherical reflector. In another form, the diverging reflector may be a spherical reflector.

Preferably, the converging reflector at least partially may comprise a substantially elliptical reflecting surface in the path of the scanned optical beam reflected from the diverging reflector such that the scanned optical beam incident on the substantially elliptical reflecting surface is reflected substantially toward the convergence spot at the pupil of the eye. In one form, the converging reflector may be an elliptical reflector. In another form, the converging reflector may be a quasi-elliptical reflector that is shaped to reduce any misconvergence of the scanned optical beam at the pupil of the eye that is caused by the shape of the diverging reflector.

Preferably, the scan source may comprise an optical beam generator for generating an optical beam, a modulator for imparting an image pixel on the optical beam at each position in the scan, and a scanner for redirecting the optical beam in a scan over in two dimensions over a scan angle in each dimension. In one form, the optical beam generator may comprise an arrangement of lasers. Alternatively, the optical beam generator of the scanner may comprise an arrangement of light emitting diodes.

In one form, the scan source may be arranged to non-linearly scan the optical beam over the scan angle in each dimension to compensate for any non-linear magnification of the scan angle at the diverging reflector to thereby ensure the image is displayed on the retina correctly.

In another form, the scan source may be arranged to non-linearly pre-distort the image to compensate for any non-linear magnification of the scan angle at the diverging reflector to thereby ensure the image is displayed on the retina correctly.

Preferably, the scan source may be arranged to scan the optical beam in two dimensions to generate a conical bundle of optical beams. More preferably, the scan source may be arranged to scan a two-dimensional image on the retina of the eye. Additionally, or alternatively, the scan source may be arranged to adjust the focus of the optical beam in accordance with the relative depth of each pixel of the image in order to display a three-dimensional image on the retina of the eye.

In one form, the converging reflector may be partially reflective and partially transparent to enable images to be superimposed onto real life scenes for augmented reality.

Preferably, the direct retinal display may further comprise a tracking control mechanism that is arranged to track movement of the eye and adjust the diverging and converging reflector positions such that the convergence spot follows the pupil as it moves. More preferably, the tracking control mechanism may further comprise retina imaging components to assist in tracking movement of the eye.

Preferably, the convergence spot may be large enough to substantially cover the pupil of the eye to reduce the effects of movement of the eye.

Preferably, the field of view produced at the eye in the horizontal direction relative to the eye may be at least 80 degrees, more preferably at least 100 degrees, and even more preferably at least 120 degrees.

Preferably, the field of view produced at the eye in the vertical direction relative to the eye may be at least 60 degrees, more preferably at least 80 degrees, and even more preferably at least 90 degrees.

Preferably, the resolution of the images displayed may be at least 800 pixels in the horizontal direction by at least 600 pixels in the vertical direction, more preferably at least 1280 pixels in the horizontal direction by at least 1024 pixels in the vertical direction, and even more preferably at least 8000 pixels in the horizontal direction by at least 5000 pixels in the vertical direction.

Preferably, the scan angle in either dimension may be at least 2 degrees, and more preferably at least 5 degrees.

Preferably, the scan angle in either dimension may be magnified by at least 20 times, and more preferably at least 25 times.

In one form, the display may be for displaying an image on the retinas of two eyes and comprises two converging reflectors, one for each eye, and the scan source is arranged to generate two scanned optical beams, modulated with the image, in two dimensions over a scan angle in each dimension toward opposite sides of a diverging reflector located between the converging reflectors, the diverging reflector being arranged to reflect each scanned optical beam, with a magnified scan angle, toward a respective converging reflector, each converging reflector being arranged to reflect each scanned optical beam substantially toward a convergence spot at the pupil of each respective eye for reconstruction and display of the image on the retina of each eye. Preferably, the converging reflectors may be quasi-elliptical reflectors that are shaped to converge the scanned optical beams to the convergence spots at the pupil of each eye and the diverging reflector is a spherical reflector.

In another form, the direct retinal display may be for displaying an image on the retinas of two eyes and comprises a scan source, diverging reflector and converging reflector for each eye.

Preferably, the direct retinal display may be arranged for mounting to the head of a user.

In a second aspect, the present invention broadly consists in a direct retinal display for displaying an image on the retina of an eye with a wide field of view comprising: a scan source that is arranged to generate a scanned optical beam in two dimensions over a scan angle in each dimension, the optical beam being modulated with the image; a diverging reflector that has a spherical reflecting surface in the path of the scanned optical beam that is arranged to reflect the scanned optical beam incident on the spherical reflecting surface outwardly with a magnified scan angle; and a converging reflector that has a substantially elliptical reflecting surface in the path of the reflected scanned optical beam that is arranged to reflect the scanned optical beam, having a magnified scan angle, substantially toward a convergence spot at the pupil of the eye for reconstruction and display of the image on the retina with a wide field of view.

Preferably, the elliptical reflecting surface of the converging reflector may be a quasi-elliptical reflecting surface that is shaped to reduce any misconvergence of the scanned optical beam at the pupil of the eye that is caused by the shape of the spherical reflecting surface of the diverging reflector.

Preferably, the scan source may comprise an optical beam generator for generating an optical beam, a modulator for imparting an image pixel on the optical beam at each position in the scan, and a scanner for redirecting the optical beam in a scan over in two dimensions over a scan angle in each dimension.

Preferably, the scan source may be arranged to non-linearly scan the optical beam over the scan angle in each dimension to compensate for any non-linear magnification of the scan angle at the diverging reflector to thereby ensure the image is displayed on the retina correctly.

Preferably, the scan source may be arranged to non-linearly pre-distort the image to compensate for any non-linear magnification of the scan angle at the diverging reflector to thereby ensure the image is displayed on the retina correctly.

Preferably, the scan source may be arranged to scan the optical beam in two dimensions to generate a conical bundle of optical beams.

Preferably, the scan source may be arranged to scan to display a two-dimensional image on the retina of the eye.

Preferably, the scan source may be arranged to adjust the focus of the optical beam in accordance with the relative depth of each pixel of the image in order to display a three-dimensional image on the retina of the eye.

In a third aspect, the present invention broadly consists in a direct retinal display for displaying an image on the retinas of two eyes of a user comprising: a scan source that is arranged to generate two scanned optical beams, one for each eye, in two dimensions over a scan angle in each dimension, the scanned optical beams being modulated with the image; a diverging reflector in the path of the scanned optical beams that is arranged to reflect the scanned optical beams incident on opposite sides of the diverging reflector outwardly with a magnified scan angle; and two converging reflectors, one for each eye, each in the path of a respective reflected scanned optical beam that are arranged to reflect the scanned optical beams, having a magnified scan angle, substantially toward a convergence spot at the pupil of each eye for reconstruction and display of the image on the retinas of the eyes with a wide field of view.

Preferably, the diverging reflector may comprise substantially spherical reflecting surfaces in the path of the scanned optical beams. More preferably, the diverging reflector may be a spherical reflector that is located between the two converging reflectors.

Preferably, the converging reflectors may comprise quasi-elliptical reflecting surfaces in the path of the scanned optical beams reflected from the diverging reflector.

In one form, there may be two diverging reflectors, one for each eye, each being located in the path of one of the scanned optical beams and being arranged to reflect the scanned optical beams onto a respective converging reflector. More preferably, the diverging reflectors may be spherical reflectors and the converging reflectors may be quasi-elliptical reflectors.

Preferably, the display may be arranged to be securable to the head of the user.

The term ‘comprising’ as used in this specification and claims means ‘consisting at least in part of’, that is to say when interpreting statements in this specification and claims which include that term, the features, prefaced by that term in each statement, all need to be present but other features can also be present.

The invention consists in the foregoing and also envisages constructions of which the following gives examples only.

### BRIEF DESCRIPTION OF THE DRAWINGS

Preferred embodiments of the invention will now be described by way of example only and with reference to the drawings, in which:

FIG. 1 is a schematic showing a preferred embodiment of the DRD of the invention that utilises a scanner, hemispherical reflector and modified elliptical reflector to produce a one-dimensional image on a retina;

FIG. 2 is a graph showing the relationship between the input scan angle (θ) and the output scan angle (φ) of the scanned beam at the hemispherical reflector;

FIG. 3 is a graph showing the relationship between the input scan angle (θ) and the pupil scan angle (β) of the scanner beam at the pupil;

FIG. 4 is a schematic showing the DRD of FIG. 1 with a non-modified elliptical reflector instead of a modified elliptical reflector and the resulting misconvergence of the rays of the scanned beam at the pupil;

FIG. 5 shows in further detail the misconverging rays of the scanned beam at the virtual origin in the hemispherical reflector that result from the use of a non-modified elliptical reflector as shown in FIG. 4;

FIG. 6 shows the overall geometry and symbols used to calculate the shape of the modified elliptical reflector;

FIG. 7 shows the generation of the modified elliptical reflector shape using points defined by multiple ellipses, only two ellipses shown;

FIG. 8 shows a close-up of a spherical reflector and relevant symbols and geometric relationships between the parameters;

FIG. 9 is a graph showing the relationship between the input scan angle (θscan) and the sphere angle (φ);

FIG. 10 is a graph showing the relationship between the input scan angle (θscan) and the reflected ray angle from horizontal (ψ);

FIG. 11 is a schematic showing a 3D wireframe model of the preferred embodiment DRD of the invention for producing a two-dimensional image on a retina;

FIG. 12 shows the intensity profile surface of a laser beam spot (exit aperture) produced by the DRD of FIG. 11 at the location of the user's pupil;

FIG. 13 shows an inverse grey level image of the intensity profile of FIG. 12;

FIG. 14 shows a side view of the preferred embodiment of the DRD of the invention mounted on a user's head;

FIG. 15 shows a plan view of the preferred embodiment of the DRD of the invention mounted on a user's head, the DRD employing a single spherical reflector; and

FIG. 16 shows a plan view of an alternative embodiment of the DRD of the invention mounted on a user's head, the DRD employing two spherical reflectors.

### DETAILED DESCRIPTION OF PREFERRED EMBODIMENTS

The present invention relates to a DRD system that produces a wide field of view, for example approximately 100 degrees horizontal and 90 degrees vertical for each eye. The DRD comprises a non-linear and non-paraxial optical design. The DRD enables a wide angle output scan from a relatively small angle input scan. In particular, the DRD utilises a diverging reflector to magnify the angle of a scanned beam from an optical source and a converging reflector to converge the beam scan back to a convergence point or spot that is substantially coincident with the pupil of the eye for reconstructions of the image on the retina of the eye. It will be appreciated that the convergence point or spot may vary in surface area size depending on the specifications of the DRD system. In the preferred form, the convergence spot substantially covers the pupil of the eye.

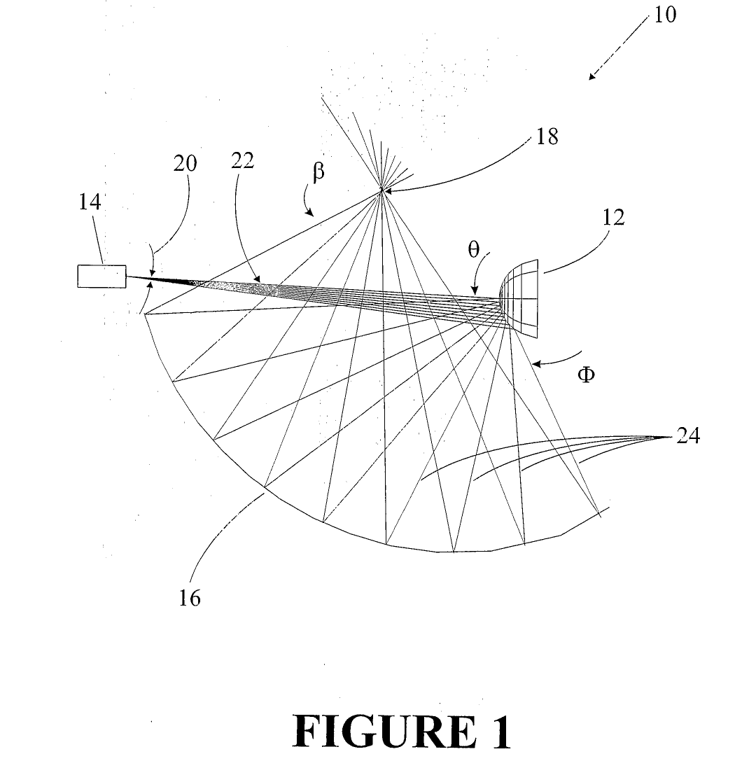

Referring to FIG. 1, a preferred embodiment of the DRD apparatus 10 is shown. As mentioned above, the DRD 10 employs non-linear optical angular magnification to produce a wide field of view (wide angle output scan) at the eye from a relatively small angle input scan. The DRD 10 uses a diverging reflector 12 to magnify a scanned beam angle from a scan source 14 in conjunction with a converging reflector 16 to converge the beam scan back to a position that is substantially coincident with the pupil 18 of the eye. With such an arrangement, the DRD 10 produces a wide field of view from a relatively small angle input scan.

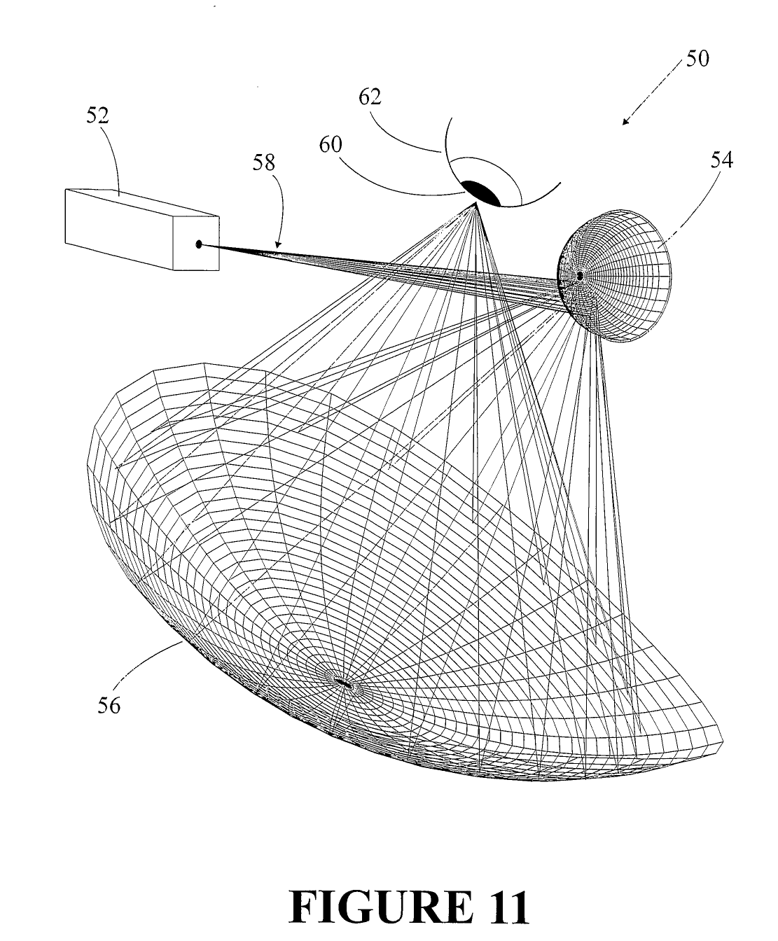

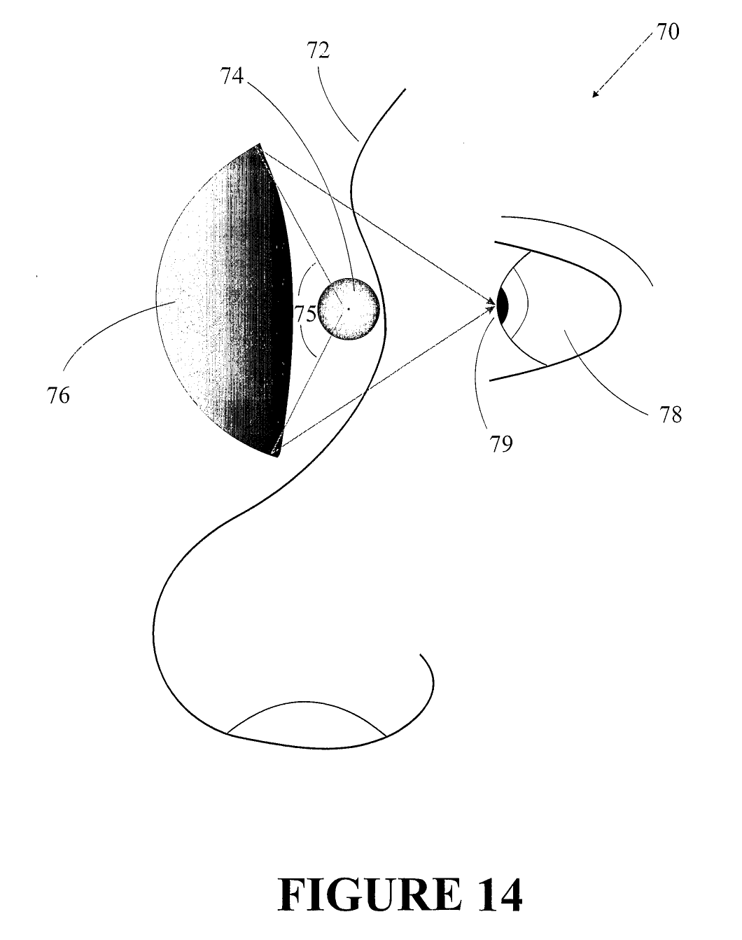

For clarity, the DRD will primarily be described in relation to producing a one-dimensional (1D—line) image with reference to a two-dimensional (2D) plan view of the DRD 10 shown in FIG. 1. However, it will be appreciated that the DRD may be arranged to produce two or three-dimensional (3D) images on the retina as will be described later in relation to FIGS. 11-16. Further, FIG. 1 shows the DRD 10 for one eye, but it will be appreciated that the DRD can be readily adapted for two eyes as required and this will also be described later in relation to FIGS. 14-16.

The DRD 10 utilises a scan source 14 that includes an optical beam generator and a scanner for scanning the beam over a desired angle 20 to produce a diverging ray bundle 22. Preferably, the optical beam generator produces a laser beam of a desired wavelength. The scanner can be any suitable technology known for scanning laser beams in DRD applications. The scanner only needs a small predetermined scan angle, such as at least 2° mechanical, and could, for example, be a tilt-tilt scanner or any other type of micro-optical electromechanical system (MOEMS) based scanner. Preferably, the scanner operates at video rates of at least 20 kHz, although it will be appreciated that lower scanner speeds may also be used depending on the application. Further, it will be appreciated that the scanner may scan the beam with one or two degrees of freedom in, for example, the horizontal or vertical directions or both, depending on whether the image is 1D, 2D or 3D. The optical beam generator may, for example, comprise an arrangement of lasers or light emitting diodes (LEDs) for generating the coloured laser beams. In the preferred embodiment, lasers are utilised in the optical beam generator. The scan source 14 also includes modulation capability to modulate image information onto the laser beams emitted from the scan source.

In operation, each laser beam in the bundle 22 that is sequentially scanned by the scan source 14 is incident on a diverging reflector 12 in its path. In the preferred embodiment shown in FIG. 1, the diverging reflector 12 is hemispherical or substantially hemispherical, although it will be appreciated that the diverging reflector may be spherical, substantially spherical or that it need only have enough of a spherical or substantially spherical surface to accommodate the incident laser beams at the lateral limits of the scan angle 20 of the ray bundle 22. If a full spherical reflector is used, the other half can form part of the diverging reflector for a DRD for the second eye of a user and this will be described later with reference to FIGS. 14-16.

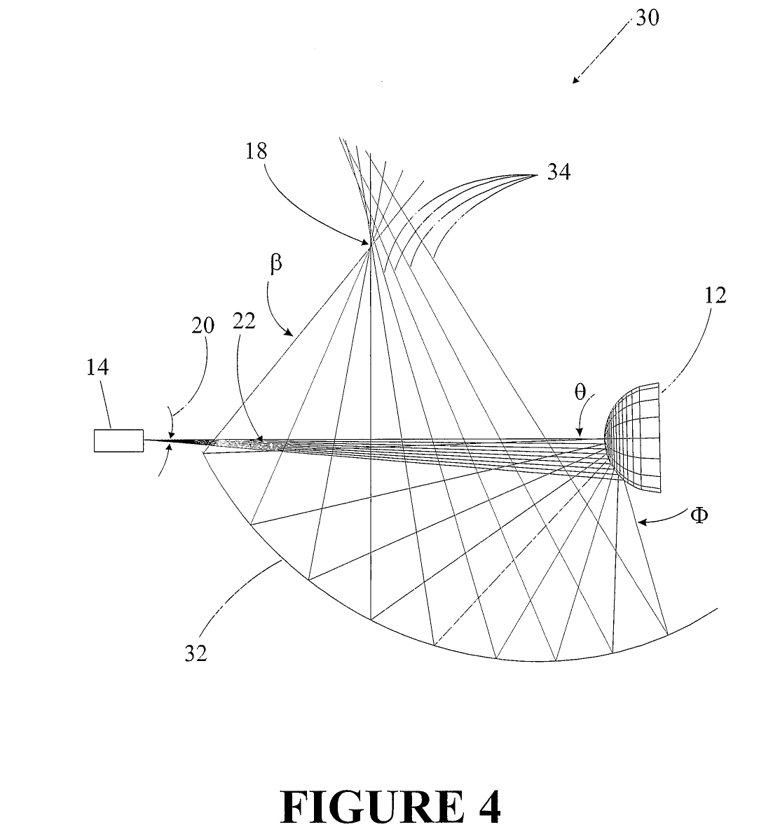

After the scanned laser beam strikes the diverging reflector 14 it is reflected off the diverging reflector onto a converging reflector 16. The converging reflector is based on an ellipse, which has the geometric property that rays originating from one focus converge on the second focus. In the preferred embodiment, the converging reflector 16 comprises a modified elliptical (quasi-elliptical) concave surface that is large enough to accommodate laser beams 24 reflecting off the diverging reflector 12 at the lateral limits of the increased scan angle. The modified elliptical reflector 16 is shaped to reconverge incident laser beams 24 reflected off the diverging reflector 12 at the pupil. The lens of the eye can then reconstruct the (in this case) one-dimensional image on the retina from the ray bundle 24. Calculation of the geometric shape of the modified elliptical reflector will be described later with reference to FIGS. 4-10.

The diverging 12 and converging 16 reflectors may be formed from glass, plastic or any other suitable material. In the preferred form, the diverging 12 reflector is shaped and polished from glass and the converging 16 reflector is formed, or injection moulded from plastic, for example acrylic. Depending on the material used to form the reflectors 12, 16, they will either have an inherent reflective quality or will be coated with a reflective coating such as protected aluminium. It will be appreciated that the diverging reflector 12 is fully reflective, but that the converging reflector may be either fully reflective or partially reflective if an augmented reality display is required whereby an image is overlays a real-life scene viewed by the user.

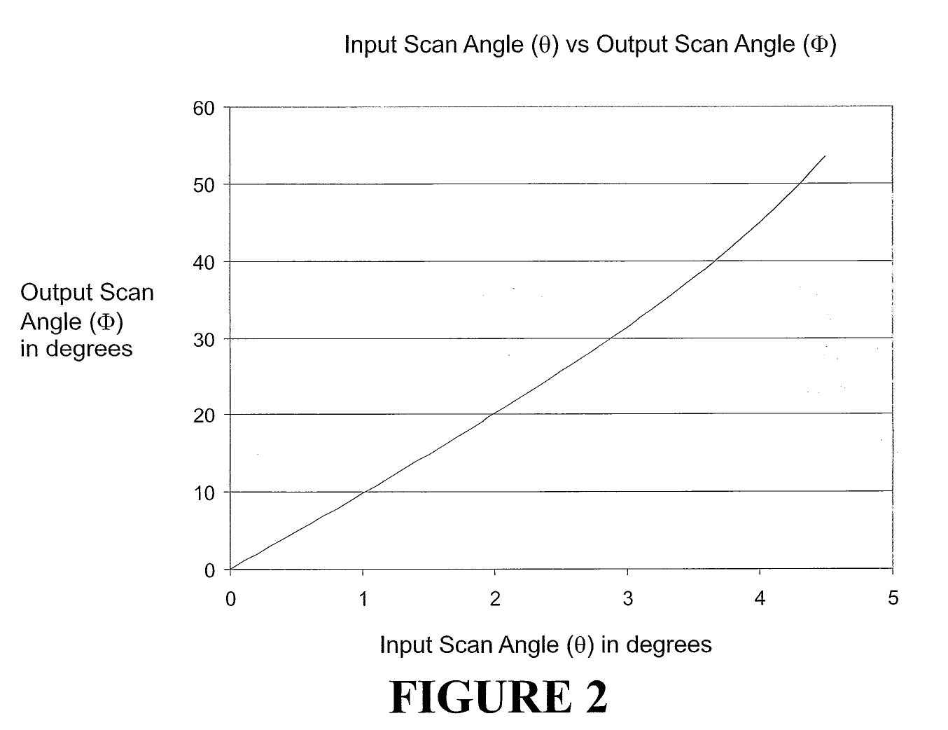

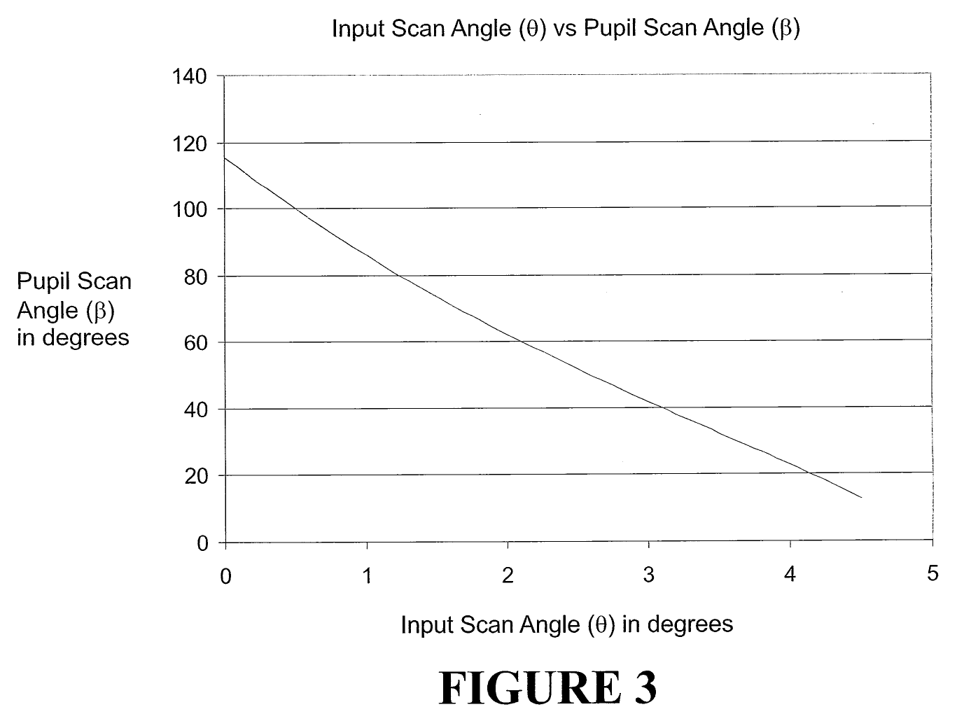

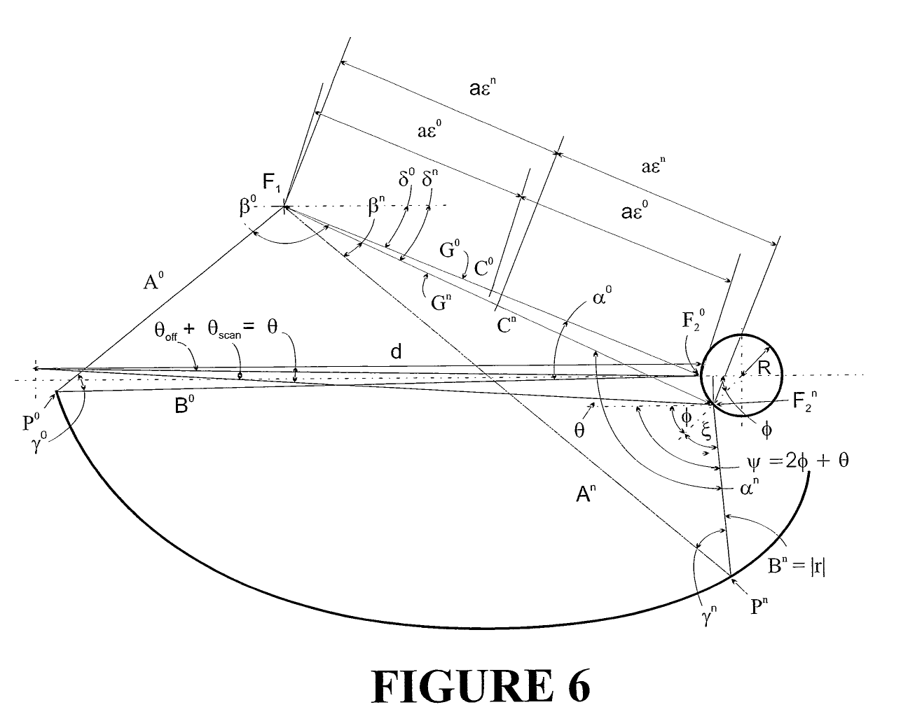

Operation of the preferred embodiment DRD shown in FIG. 1 will now be described in more detail. To produce a one-dimensional image, a laser beam from the scan source 14 is generated and scanned over an angle 20, in this case 4.5 degrees, although it will be appreciated that this input scan angle may differ depending on the application, specifications of the desired DRD and the scanner technology specifications of the scan source. At each distinct point over the scan angle 20 the laser beam is modulated to produce a distinct image carrying beam that relates to one pixel of an image for display on the retina. The combination of the individually modulated beams over the scan angle 20 comprise the image, i.e. a raster scan, which maybe Cartesian or polar in scan coordinates. The individual modulated laser beams (shown in ray bundle 22) sequentially impinge on the hemispherical reflector 12. The hemispherical reflector 12 then reflects each beam of the bundle 22 towards the quasi-elliptical reflector 16, and in doing so reflects each beam at an output angle (φ) that is dependent on its respective incident (input) angle (θ) on the hemispherical reflector 12. FIG. 2 is a graph showing the relationship between the input scan angle (θ) and the output scan angle (φ) over the 4.5 degrees, showing a scan angle magnification factor of about 12 times. FIG. 3 is a graph showing the angle at the pupil (β) for the input scan, the apparent field of view angle being the difference in the β angle for the first scan point and the last. This is better explained with reference to FIG. 6, where β° is the angle at the pupil from the first point in the scan, for example about 115 degrees, and βⁿ is the angle at the pupil from the last point in the scan, for example about 13 degrees. The difference between these two β angles is the field of view at the pupil, which in this case is over 100 degrees.

As shown in FIG. 1, the reflection angle of each beam relative to its adjacent beams changes in comparison to relative angle of the adjacent incident beams on the hemispherical reflector 12. In this manner, the ray bundle 22 divergence is increased such that the scan angle of the beams incident on the quasi-elliptical reflector 16 is greater than the scan angle 20 of the beams incident on the hemispherical reflector 12. In this case, the scan angle increases from 4.5 degrees to 53 degrees. This increases the apparent field of view, as shown in FIG. 3, of the image eventually displayed on the retina to about 22 times the original field of view. This enables the same image to be displayed in a larger format on the retina without the requirement of increasing the original scan angle at the scan source 14 and dealing with the associated problems of increasing modulation bandwidth and scan speed to retain the same resolution. The magnitude of the reflected angle (φ) depends on the sphere radius, distance of the hemispherical reflector 12 from the scan source 14 and the incident scan angle (θ).

The angular magnification factor of the hemispherical reflector 12 is not linear in relation to the incident scan angle (θ) which results in a non-linear pixel spacing on the retina. This non-linearity can be compensated for at the input scan source 14 by non-linearly scanning over the beam angle 20 to generate the required linear spacing, i.e. by pre-distorting the raster scan pattern, or alternatively by pre-distorting the image to be displayed. The diverged ray bundle 24 incident on the quasi-elliptical reflector 16 is then reconverged to a convergence point 18 coincident with the pupil of an eye. The pupil then focuses each individual beam of the bundle 24 sequentially along positions on the retina to reconstruct the image from the pixels represented by each modulated laser beam.

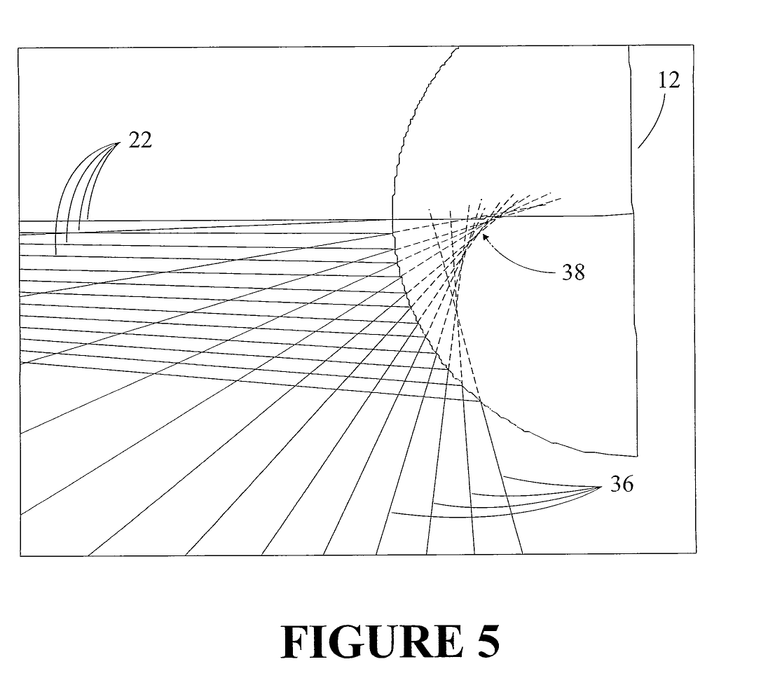

Calculation of the geometric shape of the modified elliptical reflector will now be described with reference to FIGS. 4-10. FIG. 4 shows an alternative embodiment of the DRD 30 that utilises a non-modified elliptical reflector 32 instead of a modified elliptical reflector. As shown, the non-modified elliptical reflector 32 is not preferred as it causes misconvergence 34 of the ray bundle at the pupil and this results in a degraded image. The reason for the misconvergence can be explained with reference to FIG. 5, which illustrates the beam scan rays 22 incident on the hemispherical reflector 12 and the resulting reflected rays 36. The non-modified elliptical reflector has a focal point located at the mean virtual origin 36 inside the hemispherical reflector 12 as shown in FIG. 5 and a focal point at the convergence point 18 of the eye as shown in FIG. 4. The pattern of the misconverged rays 34 is a magnified reflection of the virtual ray pattern inside the hemispherical reflector 12 at point 38. However, the surface of the non-modified elliptical reflector 32 can be modified to collect for the misconvergence of the laser beams to produce a quasi-elliptical reflector 16 as shown in the preferred embodiment DRD 10 of FIG. 1.

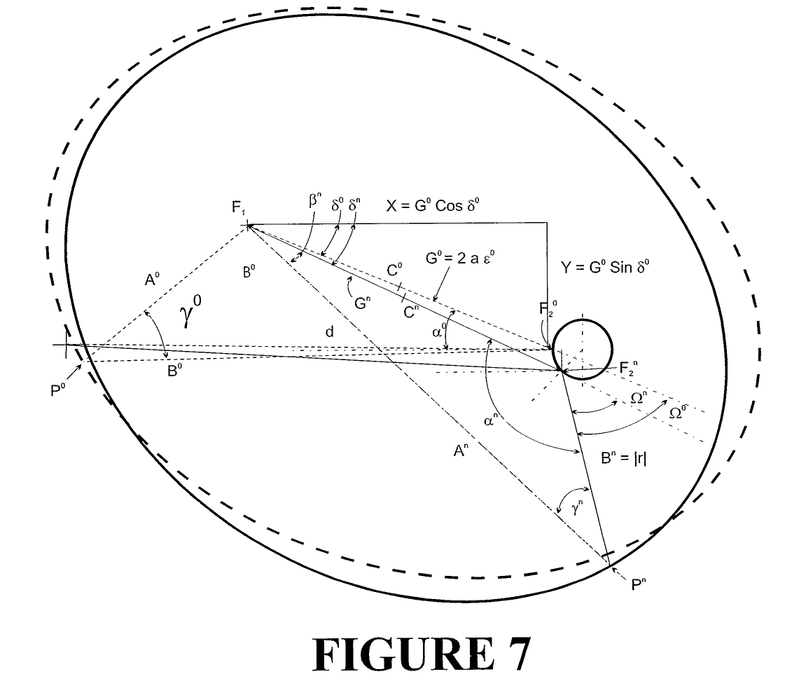

By way of example, the method of calculating the geometric shape of the modified elliptical reflector 16 or modified ellipse function in two dimensions will now be described with reference to mathematical equations and FIGS. 6-10. Firstly, an overview of the calculation process will be described. The process involves an iterative calculation that utilises the specifications and geometric parameters of the DRD 30 arrangement with a non-modified ellipse. In particular, geometric algebra is employed to effectively scan a beam across the surface of the hemispherical reflector 12 such that it is reflected onto the non-modified elliptical reflector 32 and then reflected off the elliptical reflector toward the convergence point 18 (pupil). For each beam position a set of triangles are formed as shown in FIGS. 6 and 7. The lengths and angles of these triangle sides are then calculated as will be explained further below and used to calculate a point in space, Pⁿ, which forms part of the modified ellipse or elliptical shape. Each point, Pⁿ, is then positioned to ensure that the reflected ray from the hemispherical reflector 12 is reconverged back to one point 18 coincident with the pupil. This is achieved by calculating different ellipse parameters for each beam position. The semi-major axis of the ellipse is fixed, but the eccentricity changes for each ellipse. One of the ellipse focii is fixed at a position coincident with the pupil of the eye at point 18. The other focii changes position for each different ellipse, coincident with the intercept point, F₂ⁿ, of the scanned ray on the hemispherical reflector 12 as shown in FIG. 7.

A detailed example of the mathematical calculation process will now be described with reference to mathematical equations and FIG. 6-10. The hemispherical reflector 12 is referred to as a sphere and the elliptical reflector 16 is referred to as an ellipse for this mathematical explanation. With reference to FIGS. 6-8, definitions of the variables, starting equations and solutions for generating the modified ellipse follow.

### Definition of Variables

The input angle scanned=Scan angle+Offset angle (θ=θscan+θoff).

The distance from the scan source to the sphere surface for the offset ray is d and the radius of the sphere is R.

An ellipse is formed with the focii at the pupil and the hitpoint of the ray on the sphere. With reference to FIG. 6, the focii at the pupil, F₁, remains fixed but the focii at the hitpoint on the sphere, F₂, moves as the ray is scanned, i.e. F₂ represents the hitpoint of each ray on the sphere. For each scan position (up to n) a new ellipse is generated to provide a position in space for the modified ellipse located at the ray hitpoint on the new ellipse, Pⁿ. Note that focii F₂ is superscripted with an n to indicate what number ellipse the point defines.

Ellipse parameters: Semi-major axis a, semi-minor axis b, and eccentricity ε. Note that the semi-major axis, a, is fixed, the eccentricity, ε, changes as the ellipse are generated and is indexed as a table. The points at one focii, F₁, are fixed, and those at the other foci, F₂, are not fixed and are therefore indexed as a table. Only one position (fixed at pupil) exists for the focii, F₁. The point on the ellipse surface, Pⁿ, is also indexed as a table.

The number of points needed to generate the modified ellipse to arbitrary precision is n. In particular, n=0 to the number of points required. For example, n=0 is the θoff point, i.e. θscan=0, or the first ellipse.

With reference to FIG. 7, the sides of triangles are defined by the distance between the focii, Gⁿ, and the ray hitpoint on the ellipse and the focii, Aⁿ, Bⁿ.

Opposing angles of the ellipse triangle sides use lower case greek letters corresponding to A, B, G=α, β, γ, i.e. A has opposite angle α, B has opposite angle β, and G has opposite angle γ. The angles are indexed as a list corresponding to the sides.

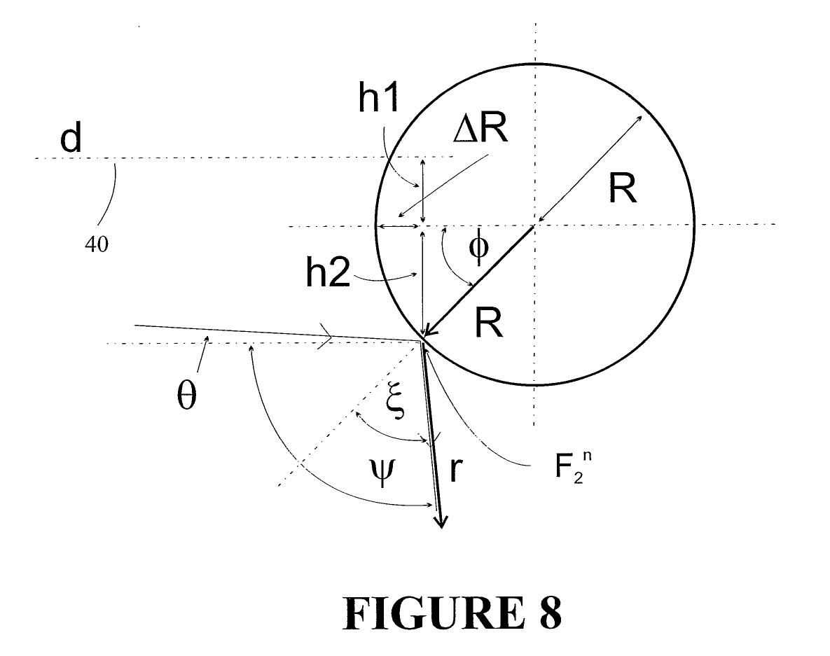

With reference to FIG. 8, the angle subtended from hitpoint and centre of sphere is φ and the reflected ray angle from horizontal is ψ. The angle of incidence and reflection from the hitpoint on the sphere is ξ. And with reference to FIGS. 6 and 7, the tilt angle of the ellipse major axis to the horizontal is δ. The angle between the triangle side, B, and the major axis of the ellipse is Ω. These angles are all indexed as tables.

With reference to FIG. 8, the radius of the sphere, R, minus the projection of the sphere hitpoint on the horizontal axis is ΔR, ΔR=R(1−cos φ). The projection of the sphere hitpoint vector, R, on the vertical axis is h2. The vertical distance the sphere is displaced from the origin of the input beam (point from which the scan originates), is h1, which is fixed and defined by the offset angle, θoff, and not an indexed table. The horizontal line to the scan beam origin is generally identifies by 40.

### Starting Equations

Express θ as a function of φ and then solve for φ. By inspection have these starting expressions/equations:

θ=θscan+θoff [1]

h1=d Tan [θoff] [2]

h2=R Sin [φ] [3]

(h1+h2)/(d+ΔR)=Tan [θ]

or

(h1+h2)=(d+ΔR) Tan [θ] [4]

Substituting equation [1] and [2] into [4] gives:

d Tan [θoff]+R Sin [φ]=(d+ΔR) Tan [θ]

or

Tan [θ]=(d Tan [θoff]+R Sin [φ])/(d+ΔR) [5]

Using, ΔR=R−R Cos [φ], from FIG. 8 gives: [6]

θ=ArcTan [(d Tan [θoff]+R Sin [φ])/(d+R−R Cos [φ])] [7]

### Solutions

Solving for φ gives:

φ=ArcCos [(−dR Tan [θoff] Tan [θoff+θscan]+dR Tan [θoff+θscan]²+R² Tan [θoff+θscan]²+√(R⁴−d²R² Tan [θoff]²+2d²R² Tan [θoff] Tan [θoff+θscan]+2dR³ Tan [θoff] Tan [θoff+θscan]−d²R² Tan [θoff+θscan]²−2dR³ Tan [θoff+θscan]²))/(R²+R² Tan [θoff+θscan]²)] [8]

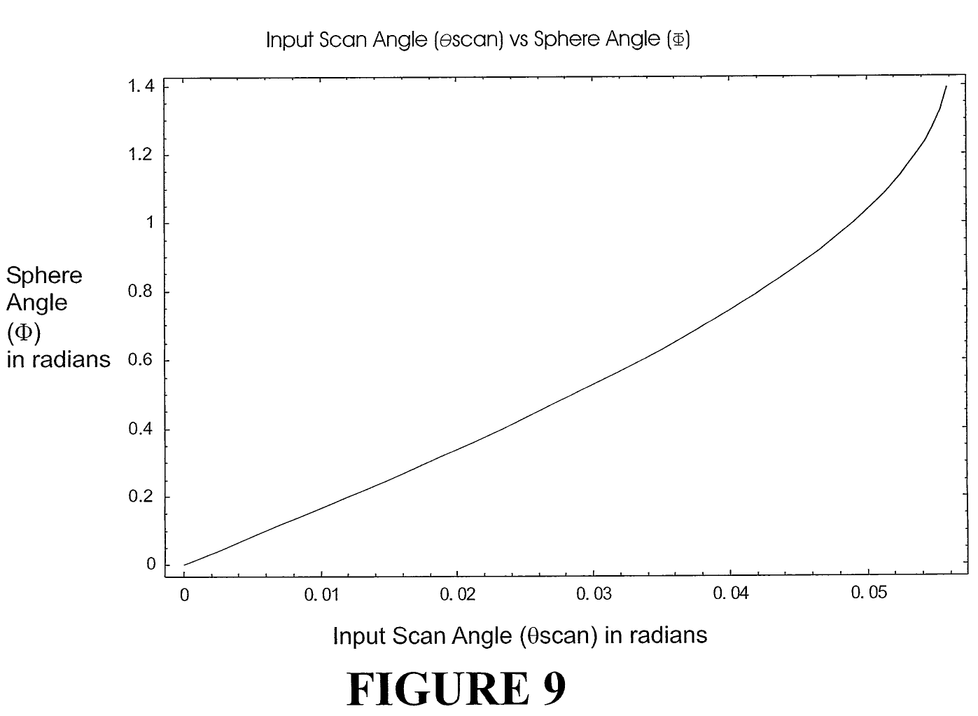

The 4th solution is used as the others are either negative or round the wrong way. Referring to FIG. 9, the relationship of the input scan angle (θscan) to the sphere angle (φ) at the hitpoints is plotted in radians.

With reference to FIG. 6, the angle that the reflected ray from the hitpoint on the sphere makes to the horizontal is defined as follows:

ψ=2φ+θ [9]

So substituting equation [7] and [8] into [9] gives:

ψ=θoff+θscan+2 ArcCos [(−dR Tan [θoff]Tan [θoff+θscan]+dR Tan [θoff+θscan]²+R² Tan [θoff+θscan]²+√(R⁴−d²R² Tan [θoff]²+2d²R² Tan [θoff] Tan [θoff+θscan]+2dR³ Tan [θoff] Tan [θoff+θscan]−d²R² Tan [θoff+θscan]²2dR³ Tan [θoff+θscan]²))/(R²+R² Tan [θoff+θscan]²)] [10]

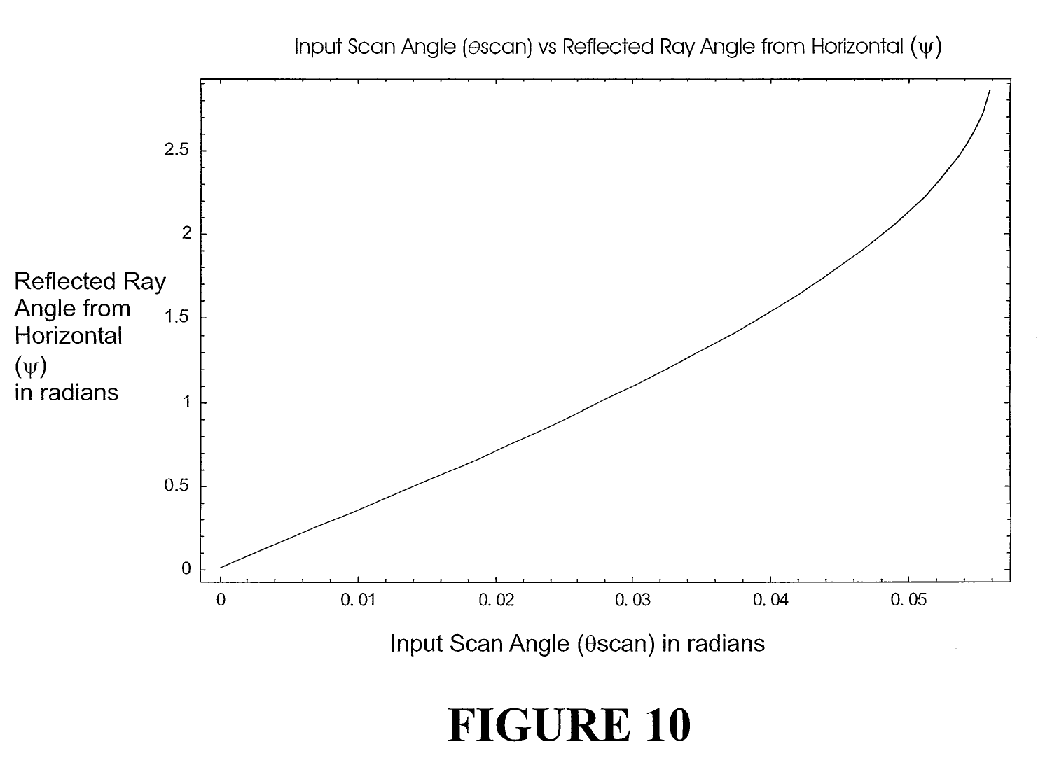

Referring to FIG. 10, the relationship of the input scan angle (θscan) to the diverging reflected ray angle from the horizontal (ψ) at the hitpoints is plotted in radians.

Now the ellipse major axis, a, is tilted by an angle, δ, and as the beam scans and the ellipses are generated with εⁿ, the tilt angle, δⁿ, changes. By inspection of the angles (π is 180 degrees in radians):

π−(Ω+δⁿ)=ψ

or

Ω=π−δⁿ−ψ [11]

Expressing r as a function of Ω, with r (or Bⁿ) being the distance from a focii (hitpoint) to a point on the ellipse at angle Ω gives:

R=a(1−ε²)/(1+ε Cos [Ω]) [12]

Setting Bⁿ=|r|, see FIG. 6 or 7, gives:

Bn=a(1−ε²)/(1+ε Cos [Ω])

Using expression [11] above for Ω gives:

$$\begin{matrix}B n = a ( 1 - {ɛ}^{2} ) / ( 1 + ɛCos [ π - {δ}^{n} - ψ ] ) \\ = a ( 1 - {ɛ}^{2} ) / ( 1 + Cos [ π - {δ}^{n} - 2 φ - θ scan - θoff ] )\end{matrix} \qquad [ 13 ]$$

With reference to FIG. 6, the horizontal sides to the triangle Gⁿ are defined as:

X=G⁰ Cos δ⁰ [14]

Y=G⁰ Sin δ⁰ [15]

and also

X+ΔR=Gⁿ Cos [δⁿ] [16]

so

Cos δⁿ=(X+ΔR)/Gⁿ [17]

Substituting equations [6] and [14] into [17] gives:

δⁿ=ArcCos [(G⁰ Cos δ⁰+R(1−Cos φ))/Gⁿ] [18]

To get an expression for Gⁿ, consider the sum or squares of the Cartesian side of Gⁿ:

Gⁿ=√((XΔR)²+(Y+h2)²) [19]

Substituting equations [3], [6], [14] and [15] into [19] gives:

Gⁿ=√((G⁰ Cos δ⁰⁺R(1−Cos [φ]))²+(G⁰ Sin δ⁰+R Sin [φ])²) [20]

Substituting [20] into equation [18] gives:

δⁿ=ArcCos [(G⁰ Cos δ⁰+R(1−Cos φ))/√((G⁰ Cos δ⁰⁺R(1−Cos [φ]))²+(G⁰ Sin δ⁰+R Sin [φ])²)] [21]

Using equations [13] and [21] provides expressions for Bⁿ, in terms of a, ε, φ, θscan, θoff, G⁰, δⁿ, and R. As shown by the solution to equation [7], φ can be expressed by R, d, θoff and θscan. R and d are known and θoff is known from the initial setup geometry, so φ can be calculated. θscan is the driving parameter that drives the whole set of equations and the generation of the ellipses. G⁰and δⁿ are also known from the initial setup geometry the only unknowns at this stage are the ellipse semi-major axis, a, and the eccentricity, ε, of the ellipses. As mentioned earlier, the semi-major axis, a, is fixed and the eccentricity, ε, varies for each ellipse.

The semi-major axis, a, can be calculated from the initial setup geometry using the ellipse standard formula:

a=(A⁰+B⁰)/2 [22]

with A⁰ and B⁰ known from the initial setup geometry.

As the ray is scanned, a set of points in space, Pⁿ is generated to define the surface of the modified ellipse in two-dimensions.

As Gⁿ=2aε, then:

εⁿ=Gⁿ/2a [23]

So the length of the triangle side Gⁿ can be used to calculate the eccentricity of the ellipses and then the eccentricity can be used to calculate Bⁿ using equation [21] for δⁿ and [13].

To get the position in space of the modified ellipse, Pⁿ, a reference point is needed. For example, the center of the sphere may be chosen as the reference point.

Referring to FIG. 8, the addition of vectors R and r is needed.

The table of positions, Pⁿ, gives the shape of the modified ellipse and can be calculated to an arbitrary accuracy by increasing n. It will be appreciated that the technique described above can be readily extended into three dimensions to generate the geometric shape of a modified ellipse for a 2D or 3D DRD.

FIG. 11 shows a preferred embodiment DRD 50 for producing a two-dimensional image on a retina of an eye. The DRD 50 arrangement is an extension of the DRD 10 of FIG. 1 for producing one-dimensional images on a retina. Like DRD 10, DRD 50 comprises a scan source 52, hemispherical reflector 54 and a modified elliptical reflector 56. The laser beams 58 generated at the scan source 52 can be scanned over two dimensions (raster scan) of the hemispherical reflector 54 and can carry a two-dimensional image that is reflected onto the modified elliptical reflector 56 (quasi-elliptical reflecting surface) and reconverged at the pupil 60 of a user's eye 62 in a two-dimensional manner for reconstruction of the image on the retina. The scanner of the scan source 52 is capable of scanning the laser beams with at least two degrees of freedom, for example in horizontal and vertical directions, to produce the cone of rays (conical bundle of rays) shown for the two-dimensional image. The non-linearity and ellipse modification techniques described above in relation to the one-dimensional scan can be readily adapted for application to a two-dimensional scan. It will be appreciated that the DRD 50 can further be adapted to provide three-dimensional images on the retina through refocusing of the beams. By adjusting the focus of laser beams appropriately, the relative depth of each pixel can be conveyed to the retina.

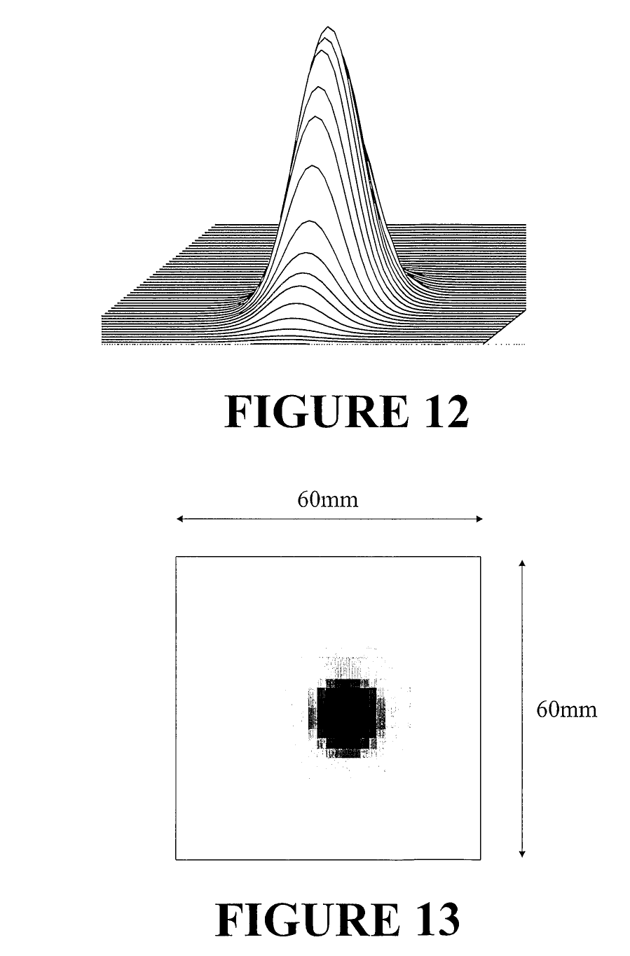

Referring to FIG. 12, the intensity profile surface of the laser beam spot, or exit aperture, produced by DRD 50 is shown. In particular, the intensity profile of the laser beam spot at the pupil 60 of a user's eye 62 is shown after reflection from the diverging hemispherical reflector 54 and the converging modified elliptical reflector 56. FIG. 13 shows the same intensity profile surface of FIG. 12 as an inverse grey level image of intensity with the darker parts of the image corresponding to more intense parts of the laser beam spot. The image of FIG. 13 has a scale to provide, by way of example, an indication of the size of the laser beam spot (exit aperture). In this case, the exit aperture has approximately a 12 mm diameter, which is a relatively large exit aperture that minimises the effects of eye movements. In particular, the exit aperture size is large enough to cover the pupil of the eye such that the laser beams still penetrate through to the retina even with modest movements of the eye. It will be appreciated that the exit aperture may be increased or reduced in size depending on the component specifications and design requirements. With larger gross movements of the eye that result in the exit aperture missing the pupil, a tracking control mechanism may be utilised to move the DRD reflecting components or scanner position to ensure the exit aperture covers the pupil of the eye as will be described later.

FIG. 14 shows a side on view of a preferred embodiment of the DRD system 70 mounted on a user's head 72. The DRD 70 utilises a scan source, diverging spherical reflector 74, and a converging modified elliptical reflector 76. In this view the scan source is not shown and the scanned laser beam is directed into the page onto the spherical reflector 74. The scanned laser beam is offset in angle and is scanned to two directions 75 to reflect off the diverging spherical reflector 74 and onto the converging modified elliptical reflector 76, which is mounted in front of the user's eye 78. The scanned laser beam is then reflected back to the user's pupil 79, producing an intensity profile like that shown in FIGS. 12 and 13.

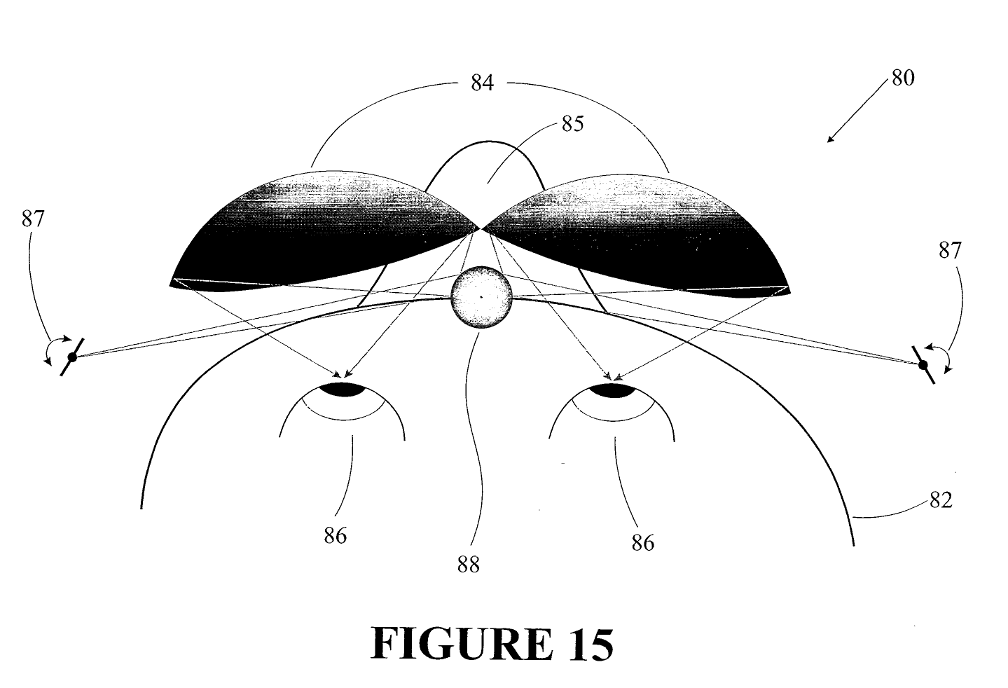

FIG. 15 shows a plan view of another preferred embodiment of the DRD system 80 mounted on a user's head 82. In this DRD 80, two converging modified elliptical reflectors 84 are shown, one for each eye 86, but only one diverging spherical reflector 88 is used, which may, for example be mounted on the bridge of the user's nose 85. The scan sources, or the scanners 87 of the scan source, are mounted on the side of the head 82 and produce a small offset scan angle that is magnified to produce over 90 degrees angle field of view at the users pupil in the vertical and/or horizontal directions.

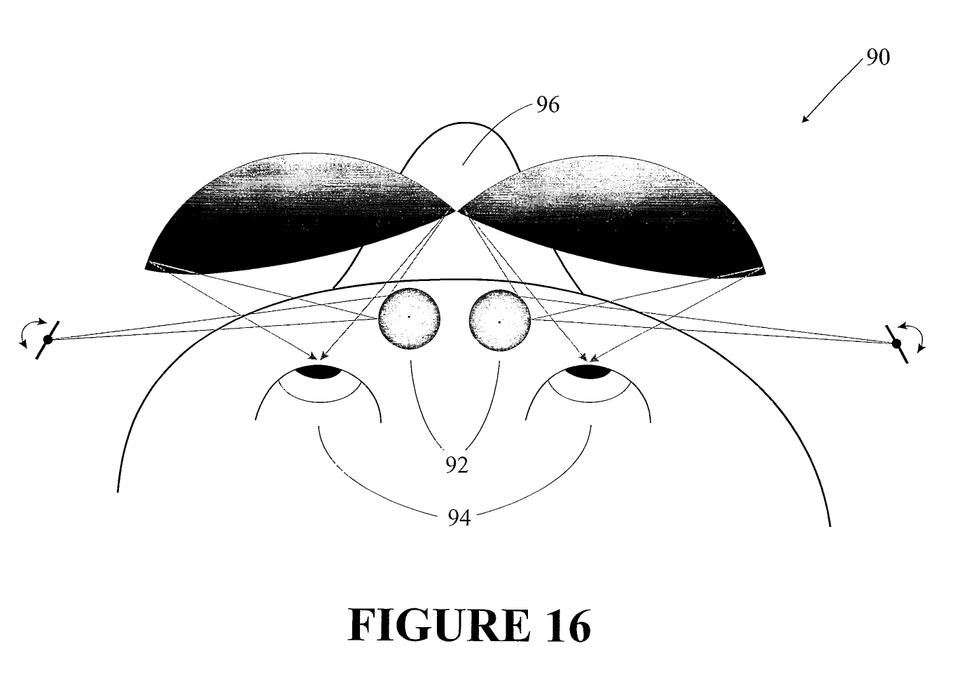

FIG. 16 shows a plan view of an alternative embodiment of the DRD system 90 that uses two diverging spherical reflectors 92 mounted near each eye 94 and on either side of the nose 96. The other components of the DRD 90 are the same as those detailed with respect to the DRD 80 of FIG. 15.

It will be appreciated that the head mounted DRDs described with reference to FIGS. 14-16 can be integrated into a pair of glasses or that the DRDs may be in the form of glasses that can be securely worn by a user. Further, it will be appreciated that the DRDs may be arranged to produce 1D, 2D or 3D images as previously discussed.

As previously mentioned, the DRDs described may be adapted to include a tracking control mechanism to move the diverging and converging reflectors to track movement of the eye to ensure continuity of the image should eye movement cause the pupil to move outside the laser beam spot (exit aperture). For example, the reflectors may be attached to each other so that they move in unison. In this manner, the first focal point of the modified elliptical reflector inside the spherical reflector remains stationary with respect to modified elliptical reflector. With this arrangement the second focal point at the pupil will move in unison with the reflectors. Further, the movements can be made to pivot around a point to mimic the movement of the eyeball in its socket. Alternatively, the field of view can be reduced slightly to allow angular movement of the whole image by the scanner to compensate for eye movement.

The DRDs described may also comprise the capability to image the network of blood vessels in the retina at the same time as displaying the image. This helps measure any eye movements for subsequent compensation to ensure the scan remains centred over the pupil and the image stationary with respect to the retina. And also, the image of the network of blood vessels can be used to uniquely identify the user of the DRD. As previously mentioned, the DRDs may also utilise a partially reflective converging reflector so that an image can overlay a real life scene. The DRDs, either in their preferred form or with additional optional features, may be implemented using micro electromechanical or micro-optical electro-mechanical systems (MEMS/MOEMS) to reduce the overall size of the devices.

In summary, the DRD of the invention provides a wide field of view by generating a wide angle output scan onto the pupil of the eye from a relatively small angle input scan that is modulated with an image. The DRD may be arranged to display images in one eye or two eyes simultaneously. The DRD may be arranged to display 1D, 2D or 3D images in colour or monochrome. The field of view in the horizontal direction relative to the eye produced by the DRD can be altered as required and is preferably at least 80 degrees, more preferably at least 100 degrees, and even more preferably at least 120 degrees to closer match the horizontal angular performance of the human eye. The field of view in the vertical direction relative to the eye produced by the DRD can also be altered as desired and is preferably at least 60 degrees, more preferably at least 80 degrees, and even more preferably at least 90 degrees to match the vertical angular performance of the human eye. The resolution (in pixels) of the images displayed by the DRD can be selected as required depending on the image source quality and is preferably at least 800×600 (horizontal×vertical), more preferably at least 1280×1024, and even more preferably at least 8000×5000 to match the resolution limit of the human eye. The input scan angle at the scan source is preferably at least 2 degrees, more preferably at least 5 degrees. It can be appreciated that magnification of the input scan angle can be adjusted by varying the distance from the scanner to the spherical reflector, d, and the radius, R, of the spherical reflector to produce the desired field of view. By way of example, the magnification factor of the input scan angle to the magnified scan angle is preferably at least 20 and more preferably at least 25. It will be appreciated that the DRD can be arranged to display still or moving (for example video) images as desired.

There are wide ranging applications which could utilise a DRD according to the invention. It can be incorporated into virtual and augmented reality display systems for entertainment, medical, military, training devices and the like.

The foregoing description of the invention includes preferred forms thereof. Modifications may be made thereto without departing from the scope of the invention as defined by the accompanying claims.

1. A direct retinal display for displaying an image on the retina of an eye with a wide field of view comprising:
a scan source that is arranged to generate a scanned optical beam in two dimensions over a scan angle in each dimension, the scanned optical beam being modulated with the image;
a diverging reflector in the path of the scanned optical beam that is arranged to reflect the scanned optical beam incident on the diverging reflector outwardly with a magnified scan angle; and
a converging reflector in the path of the reflected scanned optical beam that is arranged to reflect the scanned optical beam, having a magnified scan angle, substantially toward a convergence spot at the pupil of the eye for reconstruction and display of the image on the retina with a wide field of view.

2. A direct retinal display according to claim 1 wherein the diverging reflector at least partially comprises a spherical reflecting surface in the path of the scanned optical beam such that the scanned optical beam incident on the spherical reflecting surface is reflected at an altered angle to magnify the scan angle to create the wide field of view.

3. A direct retinal display according to claim 2 wherein the diverging reflector is a hemispherical reflector.

4. A direct retinal display according to claim 2 wherein the diverging reflector is a spherical reflector.

5. A direct retinal display according to claim 1 wherein the converging reflector at least partially comprises a substantially elliptical reflecting surface in the path of the scanned optical beam reflected from the diverging reflector such that the scanned optical beam incident on the substantially elliptical reflecting surface is reflected substantially toward the convergence spot at the pupil of the eye.

6. A direct retinal display according to claim 5 wherein the converging reflector is an elliptical reflector.

7. A direct retinal display according to claim 5 wherein the converging reflector is a quasi-elliptical reflector that is shaped to reduce any misconvergence of the scanned optical beam at the pupil of the eye that is caused by the shape of the diverging reflector.

8. A direct retinal display according to claim 1 wherein the scan source comprises an optical beam generator for generating an optical beam, a modulator for imparting an image pixel on the optical beam at each position in the scan, and a scanner for redirecting the optical beam in two dimensions over a scan angle in each dimension.

9. A direct retinal display according to claim 8 wherein the optical beam generator comprises an arrangement of lasers.

10. A direct retinal display according to claim 8 wherein the optical beam generator of the scanner comprises an arrangement of light emitting diodes.

11. A direct retinal display according to claim 1 wherein the scan source is arranged to non-linearly scan the optical beam over the scan angle in each dimension to compensate for any non-linear magnification of the scan angle at the diverging reflector to thereby ensure the image is displayed on the retina correctly.

12. A direct retinal display according to claim 1 wherein the scan source is arranged to non-linearly pre-distort the image to compensate for any non-linear magnification of the scan angle at the diverging reflector to thereby ensure the image is displayed on the retina correctly.

13. A direct retinal display according to claim 1 wherein the scan source is arranged to scan the optical beam in two dimensions to generate a conical bundle of optical beams.

14. A direct retinal display according to claim 1 wherein the scan source is arranged to scan a two-dimensional image on the retina of the eye.

15. A direct retinal display according to claim 1 wherein the scan source is arranged to adjust the focus of the optical beam in accordance with the relative depth of each pixel of the image in order to display a three-dimensional image on the retina of the eye.

16. A direct retinal display according to claim 1 wherein the converging reflector is partially reflective and partially transparent to enable images to be superimposed onto real life scenes for augmented reality.

17. A direct retinal display according to claim 1 wherein the convergence spot is large enough to substantially cover the pupil of the eye to reduce the effects of movement of the eye.

18. A direct retinal display according to claim 1 wherein the field of view produced at the eye in the horizontal direction relative to the eye is at least 80 degrees.

19. A direct retinal display according to claim 1 wherein the field of view produced at the eye in the horizontal direction relative to the eye is at least 100 degrees.

20. A direct retinal display according to claim 1 wherein the field of view produced at the eye in the horizontal direction relative to the eye is at least 120 degrees.

21. A direct retinal display according to claim 1 wherein the field of view produced at the eye in the vertical direction relative to the eye is at least 60 degrees.

22. A direct retinal display according to claim 1 wherein the field of view produced at the eye in the vertical direction relative to the eye is at least 80 degrees.

23. A direct retinal display according to claim 1 wherein the field of view produced at the eye in the vertical direction relative to the eye is at least 90 degrees.

24. A direct retinal display according to claim 1 wherein the resolution of the images displayed is at least 800 pixels in the horizontal direction by at least 600 pixels in the vertical direction.

25. A direct retinal display according to claim 1 wherein the resolution of the images displayed is at least 1280 pixels in the horizontal direction by at least 1024 pixels in the vertical direction.

26. A direct retinal display according to claim 1 wherein the resolution of the images displayed is at least 8000 pixels in the horizontal direction by at least 5000 pixels in the vertical direction.

27. A direct retinal display according to claim 1 wherein the scan angle in either dimension is at least 2 degrees.

28. A direct retinal display according to claim 1 wherein the scan angle in either dimension is at least 5 degrees.

29. A direct retinal display according to claim 1 wherein the scan angle in either dimension is magnified by at least 20 times.

30. A direct retinal display according to claim 1 wherein the scan angle in either dimension is magnified by at least 25 times.

31. A direct retinal display according to claim 1 wherein the display is for displaying an image on the retinas of two eyes and comprises two converging reflectors, one for each eye, and the scan source is arranged to generate two scanned optical beams, modulated with the image, in two dimensions over a scan angle in each dimension toward opposite sides of a diverging reflector located between the converging reflectors, the diverging reflector being arranged to reflect each scanned optical beam, with a magnified scan angle, toward a respective converging reflector, each converging reflector being arranged to reflect each scanned optical beam substantially toward a convergence spot at the pupil of each respective eye for reconstruction and display of the image on the retina of each eye.

32. A direct retinal display according to claim 31 wherein the converging reflectors are quasi-elliptical reflectors that are shaped to converge the scanned optical beams to the convergence spots at the pupil of each eye and the diverging reflector is a spherical reflector.

33. A direct retinal display according to claim 1 wherein the direct retinal display is for displaying an image on the retinas of two eyes and comprises a scan source, diverging reflector and converging reflector for each eye.

34. A direct retinal display according to claim 1 wherein the direct retinal display is arranged for mounting to the head of a user.

35. A direct retinal display for displaying an image on the retina of an eye with a wide field of view comprising:
a scan source that is arranged to generate a scanned optical beam in two dimensions over a scan angle in each dimension, the optical beam being modulated with the image;
a diverging reflector that has a spherical reflecting surface in the path of the scanned optical beam that is arranged to reflect the scanned optical beam incident on the spherical reflecting surface outwardly with a magnified scan angle; and
a converging reflector that has a substantially elliptical reflecting surface in the path of the reflected scanned optical beam that is arranged to reflect the scanned optical beam, having a magnified scan angle, substantially toward a convergence spot at the pupil of the eye for reconstruction and display of the image on the retina with a wide field of view.

36. A direct retinal display according to claim 35 wherein the elliptical reflecting surface of the converging reflector is a quasi-elliptical reflecting surface that is shaped to reduce any misconvergence of the scanned optical beam at the pupil of the eye that is caused by the shape of the spherical reflecting surface of the diverging reflector.

37. A direct retinal display according to claim 35 wherein the scan source comprises an optical beam generator for generating an optical beam, a modulator for imparting an image pixel on the optical beam at each position in the scan, and a scanner for redirecting the optical beam in two dimensions over a scan angle in each dimension.

38. A direct retinal display according to claim 35 wherein the scan source is arranged to non-linearly scan the optical beam over the scan angle in each dimension to compensate for any non-linear magnification of the scan angle at the diverging reflector to thereby ensure the image is displayed on the retina correctly.

39. A direct retinal display according to claim 35 wherein the scan source is arranged to non-linearly pre-distort the image to compensate for any non-linear magnification of the scan angle at the diverging reflector to thereby ensure the image is displayed on the retina correctly.

40. A direct retinal display according to claim 35 wherein the scan source is arranged to scan the optical beam in two dimensions to generate a conical bundle of optical beams.

41. A direct retinal display according to claim 35 wherein the scan source is arranged to scan to display a two-dimensional image on the retina of the eye.

42. A direct retinal display according to claim 35 wherein the scan source is arranged to adjust the focus of the optical beam in accordance with the relative depth of each pixel of the image in order to display a three-dimensional image on the retina of the eye.

43. A direct retinal display for displaying an image on the retinas of two eyes of a user comprising:
a scan source that is arranged to generate two scanned optical beams, one for each eye, in two dimensions over a scan angle in each dimension, the scanned optical beams being modulated with the image;
a diverging reflector in the path of the scanned optical beams that is arranged to reflect the scanned optical beams incident on opposite sides of the diverging reflector outwardly with a magnified scan angle; and
two converging reflectors, one for each eye, each in the path of a respective reflected scanned optical beam that are arranged to reflect the scanned optical beams, having a magnified scan angle, substantially toward a convergence spot at the pupil of each eye for reconstruction and display of the image on the retinas of the eyes with a wide field of view.

44. A direct retinal display according to claim 43 wherein the diverging reflector comprises substantially spherical reflecting surfaces in the path of the scanned optical beams.

45. A direct retinal display according to claim 43 wherein the diverging reflector is a spherical reflector that is located between the two converging reflectors.

46. A direct retinal display according to claim 43 wherein the converging reflectors comprise quasi-elliptical reflecting surfaces in the path of the scanned optical beams reflected from the diverging reflector.

47. A direct retinal display according to claim 43 wherein there are two diverging reflectors, one for each eye, each being located in the path of one of the scanned optical beams and being arranged to reflect the scanned optical beams onto a respective converging reflector.

48. A direct retinal display according to claim 47 wherein the diverging reflectors are spherical reflectors and the converging reflectors are quasi-elliptical reflectors.

49. A direct retinal display according to claim 43 wherein the display is arranged to be securable to the head of the user.
